(19) United States
(12) Patent Application Publication
(10) Pub. No.: US 2005/0094887 A1
(43) Pub. Date: May 5, 2005

(54) Methods, systems and computer program products for fusion of high spatial resolution imagery with lower spatial resolution imagery using correspondence analysis

(76) Inventors: Halil I. Cakir, Raleigh, NC (US); Siamak Khorram, Raleigh, NC (US)

Correspondence Address: MYERS BIGEL SIBLEY & SAJOVEC, PO BOX 37428, RALEIGH, NC, 27627, US

(21) Appl. No.: 10/982,054

(22) Filed: Nov. 4, 2004

Related U.S. Application Data
(60) Provisional application No. 60/517,427, filed on Nov. 5, 2003.

(51) Int. Cl. G06K 9/00; G06K 9/32

(52) U.S. Cl. 382/254; 382/299

(57) ABSTRACT

Methods, systems and computer program products are provided for fusing images having different spatial resolutions, for example, different spatial and/or spectral resolutions. Data for at least two images having different spatial resolutions is obtained. A component analysis transform is performed on a lower spatial resolution image of the at least two images. A component of the component analysis transform of the lower resolution image containing a small amount of information associated with the low spatial resolution image is replaced with information from a higher spatial resolution image of the at least two images.

### CLAIM OF PRIORITY

The present application claims the benefit of U.S. Provisional Application Ser. No. 60/517,427 (Attorney Docket No. 5051 -648PR), filed Nov. 5, 2003, the disclosure of which is hereby incorporated by reference as if set forth in its entirety.

### FIELD OF THE INVENTION

The present invention relates generally to data fusion and, more particularly, to the fusion of images having different resolutions, for example, spatial and spectral resolutions.

### BACKGROUND OF THE INVENTION

There are many conventional techniques used for data fusion of images with different spatial and/or spectral resolutions. Examples of some of these techniques are discussed in U.S. Pat. Nos. 6,097,835; 6,011,875; 4,683,496 and 5,949,914. Furthermore, two techniques that are widely used for data fusion of images with different resolutions are the Principal Component Analysis (PCA) method and the Multiplicative method. The PCA method may be used for, for example, image encoding, image data compression, image enhancement, digital change detection, multi-temporal dimensionality and image fusion and the like as discussed in Multisensor Image Fusion in Remote Sensing: Concepts, Methods and Applications by Pohl et al. (1998). The PCA method calculates the principal components (PCs) of a low spatial resolution image, for example, a color image, re-maps a high spatial resolution image, for example, a black and white image, into the data range of a first of the principal components (PC-1) and substitutes the high spatial resolution image for the PC-1. The PCA method may then apply an inverse principal components transform to provide the fused image. The Multiplicative method is based on a simple arithmetic integration of the two data sets as discussed below.

There are several ways to utilize the PCA method when fusing high spectral resolution multispectral data, for example, color images, with high spatial resolution panchromatic data, for example, black and white images. The most commonly used way to utilize the PCA method involves the utilization of all input bands from multispectral data. In this method, multispectral data may be transformed into principal component (PC) space using either co-variance or a correlation matrix. A first PC image of the multispectral data may be re-mapped to have approximately the same amount of variance and the same average with a corresponding high spatial resolution image. The first PC image may be replaced with the high spatial resolution image in components data. An inverse PCA transformation may be applied to the components data set including the replaced first PC image to provide the fused image.

The PCA method replaces the first PC image with the high spatial resolution data because the first PC image (PC I) has the information common to all bands in multispectral data, which is typically associated with spatial details. However, since the first PC image accounts for most of the variances in multispectral data, replacing the first PC image with the high spatial resolution data may significantly affect the final fused image. In other words, the spectral characteristic of the final fused image may be altered. Accordingly, there may be an increased correlation between the fused image bands and high spatial resolution data.

Using the Multiplicative method, a multispectral image (color image) may be multiplied by a higher spatial resolution panchromatic image (black and white image) to increase the spatial resolution of the multispectral image. After multiplication, pixel values may be rescaled back to the original data range. For example, with 8-bit data, pixel values range between 0 and 255. This is the radiometric resolution of 8-bit data. After multiplication, these values may exceed the radiometric resolution range of input data. To keep the output (fused) image within the data range of input data, data values may be rescaled back to so to fall within the 0-255 range to have the same radiometric resolution with the input data.

The Multiplicative method may increase the intensity component, which may be good for highlighting urban features. The resulting fused image of the Multiplicative method may have increased correlation to the panchromatic image. Thus, spectral variability may be decreased in the output (fused) image compared to the original (input) multispectral image. In other words, the fused image resulting from the multispectral method may also have altered spectral characteristics. Thus, improved methods of fusing images having different spatial and/or spectral resolutions may be desired.

### SUMMARY OF THE INVENTION

Embodiments of the present invention provide methods, systems and computer program products for fusing images having different spatial resolutions, for example, different spatial and/or spectral resolutions. Data for at least two images having different spatial resolutions is obtained. A component analysis transform is performed on a lower spatial resolution image of the at least two images. A component of the component analysis transform of the lower resolution image containing a small amount of information associated with the low spatial resolution image is replaced with information from a higher spatial resolution image of the at least two images.

In some embodiments of the present invention, an inverse transform of the component analysis transform of the lower spatial resolution image having the replaced component is performed. The higher spatial resolution image may be modified to have the same range and average values as the component containing a small amount of information associated with the low spatial image and the component of the component analysis transform of the lower spatial resolution image containing a small amount of information associated with the low spatial resolution image may be replaced with the modified higher spatial image.

In some embodiments of the present invention, a ratio of pixel values associated with the high spatial resolution image and pixel values associated with the low resolution image may be generated to provide spatial details and the spatial details may be inserted into the component of the component analysis transform of the lower spatial resolution image containing a small amount of information associated with the low spatial resolution image. The spatial details may be inserted by multiplying or dividing the spatial details with the component of the component analysis transform of the lower spatial resolution image containing a small amount of information associated with the low spatial resolution image.

In further embodiments of the present invention, the component containing the small amount of information associated with the low spatial resolution image may be highly correlated with the higher spatial resolution image. The information from the higher spatial resolution image may include the higher spatial resolution image scaled to correspond to a range of values in the component containing a small amount of information associated with the low spatial resolution image. In certain embodiments of the present invention, the information from the higher spatial resolution image may include detail information obtained from the higher spatial resolution image.

In still further embodiments of the present invention, the component of the lower spatial resolution image containing a small amount of information associated with the low spatial resolution image may include less than about five percent of the information associated with the low spatial resolution image. The component of the component analysis transform of the lower resolution image may include a last component of the component analysis transform, the high spatial resolution image may include a panchromatic and/or a black and white image and the low spatial resolution image may include a multispectral and/or a color image. The lower spatial resolution image may include a higher spectral resolution than the higher spatial resolution image.

### BRIEF DESCRIPTION OF THE FIGURES

FIG. 1 is a block diagram of data processing systems suitable for use in some embodiments of the present invention.

FIG. 2 is a more detailed block diagram of aspects of data processing systems that may be used in some embodiments of the present invention.

FIG. 3 is a flowchart illustrating operations according to some embodiments of the present invention.

FIGS. 4A and 4B is a flowchart illustrating operations according to further embodiments of the present invention.

FIGS. 5A and 5B is a flowchart of operations according to still further embodiments of the present invention.

FIG. 6 is a flowchart illustrating operations according to some embodiments of the present invention.

FIG. 7 is a flowchart illustrating operations according to still further embodiments of the present invention.

FIG. 8 is a side by side display illustrating original and fused images created using different methods for comparison purposes.

FIG. 9 is a graph of the correlation coefficients illustrating panchromatic data versus original and fused images.

FIG. 10 is a graph of between-band correlation coefficients illustrating original, Component Analysis (CA) method 1, CA method 2, and PCA method images.

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The invention is described in part below with reference to flowchart illustrations and/or block diagrams of methods, systems, and computer program products according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

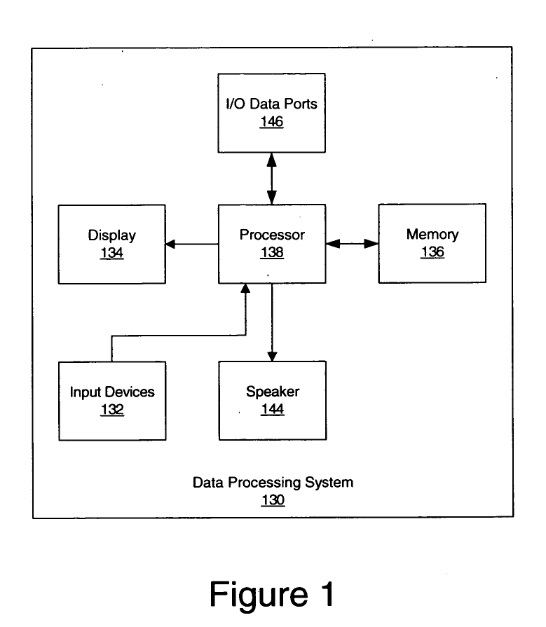

Embodiments of the present invention will now be described with respect to FIGS. 1 through 10. Some embodiments of the present invention provide methods, systems and computer program products for fusing images having different spatial resolutions. Data for at least two images having different spatial resolutions, for example, different spatial and/or spectral resolutions, is obtained. A component analysis (CA) transform is performed on a lower spatial resolution image, for example, a color image, of the at least two images. A component of the component analysis transform of the lower resolution image containing a small amount of information associated with the low spatial resolution image is replaced with information from a higher spatial resolution image, for example, a black and white image, of the at least two images. Because some embodiments of the present invention replace a component containing a small amount of information associated with the low spatial resolution image, for example, less than about five percent, most of the spectral characteristics of the original image may be maintained in the fused image as discussed further herein below.

Referring now to FIG. 1, an exemplary embodiment of data processing systems 130 suitable for data fusion in accordance with some embodiments of the present invention will be discussed. The data processing system 130 typically includes input device(s) 132 such as a keyboard, pointer, mouse and/or keypad, a display 134, and a memory 136 that communicate with a processor 138. The data processing system 130 may further include a speaker 144, and an I/O data port(s) 146 that also communicate with the processor 138. The I/O data ports 146 can be used to transfer information between the data processing system 130 and another computer system or a network. These components may be conventional components, such as those used in many conventional data processing systems, which may be configured to operate as described herein.

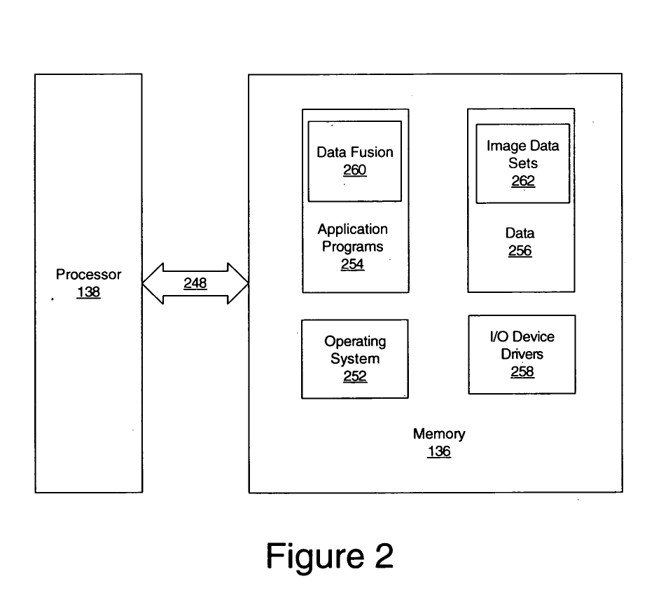

Referring now to FIG. 2, a block diagram of data processing systems that illustrate systems, methods, and computer program products in accordance with some embodiments of the present invention will be discussed. The processor 138 communicates with the memory 136 via an address/data bus 248. The processor 138 can be any commercially available or custom microprocessor. The memory 136 is representative of the overall hierarchy of memory devices, and may contain the software and data used to implement the functionality of the data processing system 130. The memory 136 can include, but is not limited to, the following types of devices: cache, ROM, PROM, EPROM, EEPROM, flash memory, SRAM, and DRAM.

As shown in FIG. 2, the memory 136 may include several categories of software and data used in the data processing system 130: the operating system 252; the application programs 254; the input/output (I/O) device drivers 258; and the data 256. As will be appreciated by those of skill in the art, the operating system 252 may be any operating system suitable for use with a data processing system, such as OS/2, AIX or System390 from International Business Machines Corporation, Armonk, N.Y., Windows95, Windows98, Windows2000 or WindowsXP from Microsoft Corporation, Redmond, Wash., Unix or Linux. The I/O device drivers 258 typically include software routines accessed through the operating system 252 by the application programs 254 to communicate with devices such as the I/O data port(s) 146 and certain memory 136 components. The application programs 254 are illustrative of the programs that implement the various features of the data processing system 130 and preferably include at least one application that supports operations according to embodiments of the present invention. Finally, the data 256 represents the static and dynamic data used by the application programs 254, the operating system 252, the I/O device drivers 258, and other software programs that may reside in the memory 136.

As is further illustrated in FIG. 2, the application programs 254 may include a data fusion module 260. The data fusion module 260 may carry out the operations described herein for the fusion of different resolution data from image data sets, such as the image data sets 262. While the present invention is illustrated, for example, with reference to the data fusion module 260 being an application program in FIG. 2, as will be appreciated by those of skill in the art, other configurations may also be utilized. For example, the data fusion module 260 may also be incorporated into the operating system 252, the I/O device drivers 258 or other such logical division of the data processing system 130. Thus, the present invention should not be construed as limited to the configuration illustrate of FIG. 2 but encompasses any configuration capable of carrying out operations according to embodiments of the present invention described herein.

In particular embodiments of the present invention, data fusion is carried out on a desktop PC environment. However, data fusion according to embodiments of the present invention may be performed on any hardware that has adequate processing capabilities for image processing such as workstations, desktop computers, laptops, and the like without departing from the scope of the present invention.

The software used for initial development of embodiments of the present invention is “ERDAS IMAGINE 8.2 ©”, which is a professional image processing software for remotely sensed data. The code is written in the “modeler” extension of IMAGINE. The code is provided in three supporting IMAGINE modeler files. However, it will be understood that the code can be written in any development language package or environment including but not limited to C⁺⁺, Fortran, Visual Basic, Pascal, Matlab, and the like without departing from the present invention. The operating environment can be any computing environment including, but not limited to, any Windows platform, DOS, Linux or Unix platform.

As discussed above, the data fusion circuit 260 may be configured to fuse images having different resolutions, for example, spatial and/or spectral resolutions. In particular, the data fusion circuit 260 may be configured to obtain image data sets 262 for at least two images having different spatial resolutions. For example, in some embodiments of the present invention, the obtained data may include remotely sensed data including but not limited to aerial or satellite imagery. Data from satellites such as IKONOS, Quickbird, SPOT, Landsat, and the like may be used without departing from the scope of the present invention. However, it will be understood that embodiments of the present invention are not limited to such images but may be used with any type of image data that has different spatial and/or spectral resolutions. For example, some embodiments of the present invention may be used with respect to, for example, medical imaging data. In some embodiments of the present invention the obtained images may be multispectral images, for example, color images, and high spatial resolution images, such as a panchromatic image or black and white image. In these embodiments of the present invention, both input images, i.e., the multispectral and high spatial resolution images, may be co-registered to each other so that the same objects in each image may appear at relatively the same place.

Once the image data for at least two images having different spatial resolutions are obtained, a component analysis (CA) transform may be performed on a lower spatial resolution image, for example, a multispectral or color image, of the at least two images, which may produce two or more components of the image each containing a certain percentage of the original image information. For example, the CA transform may produce four components associated with the input multispectral image. Each of the four components may contain a certain percentage of the original multispectral image information, for example, the first component may contain about 97% percent of the information contained in the original (input) image, the second component may include about 2% of the information contained in the original image, the third component may contain less than about 1% of the information contained in the original image and the fourth component may contain less than half a percent of the information contained in the original image. It will be understood that these values are provided for exemplary purposes only and that embodiments of the present invention should be limited to these exemplary values.

The data fusion circuit 260 may be further configured to replace a component of the component analysis transform of the lower resolution image containing a small amount of information associated with the low spatial resolution image with information from a higher spatial resolution image, for example, a panchromatic or black and white image, of the at least two images. In other words, for example, one of the four components is replaced with information from a corresponding higher spatial resolution image. As used herein, “containing a small amount of information associated with the low spatial resolution image” refers to having less than about five percent of the information associated with the low spatial resolution image. Thus, any of the second through fourth components in the example set out above may be replaced with the information from the higher spatial resolution image. In some embodiments of the present invention, the last component, component four in the example above, may be replaced with the high spatial resolution image. The last component and the high spatial resolution image may be highly correlated. Thus, replacing the last component with the high spatial resolution image may not significantly affect the spectral characteristics of the original image.

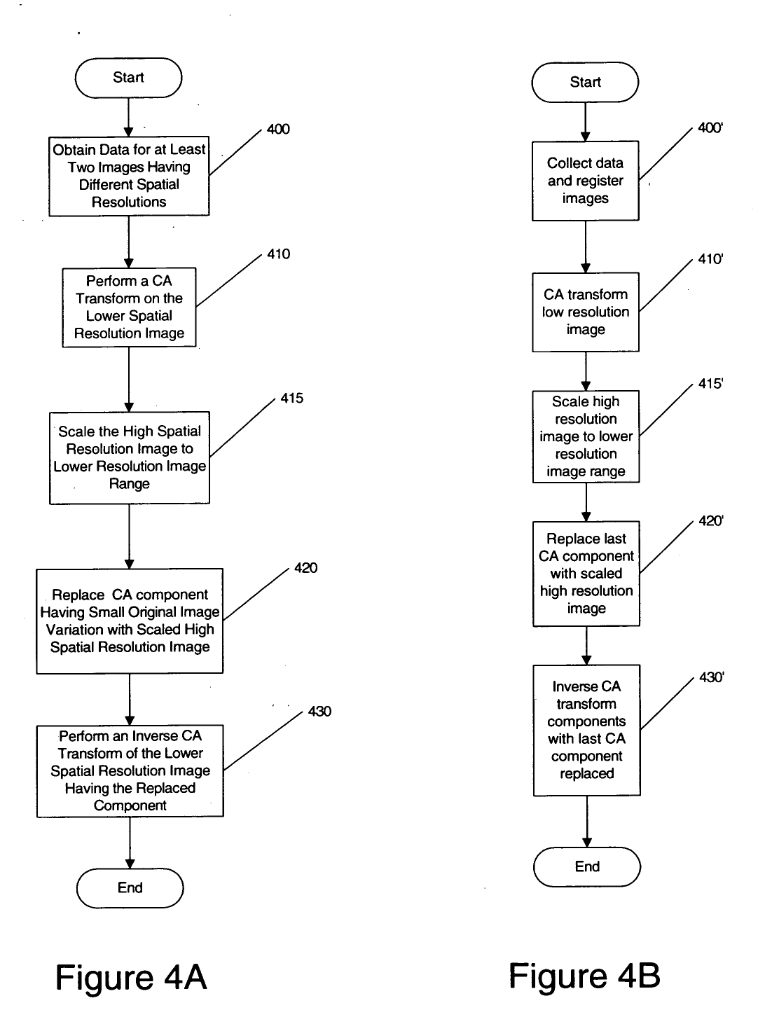

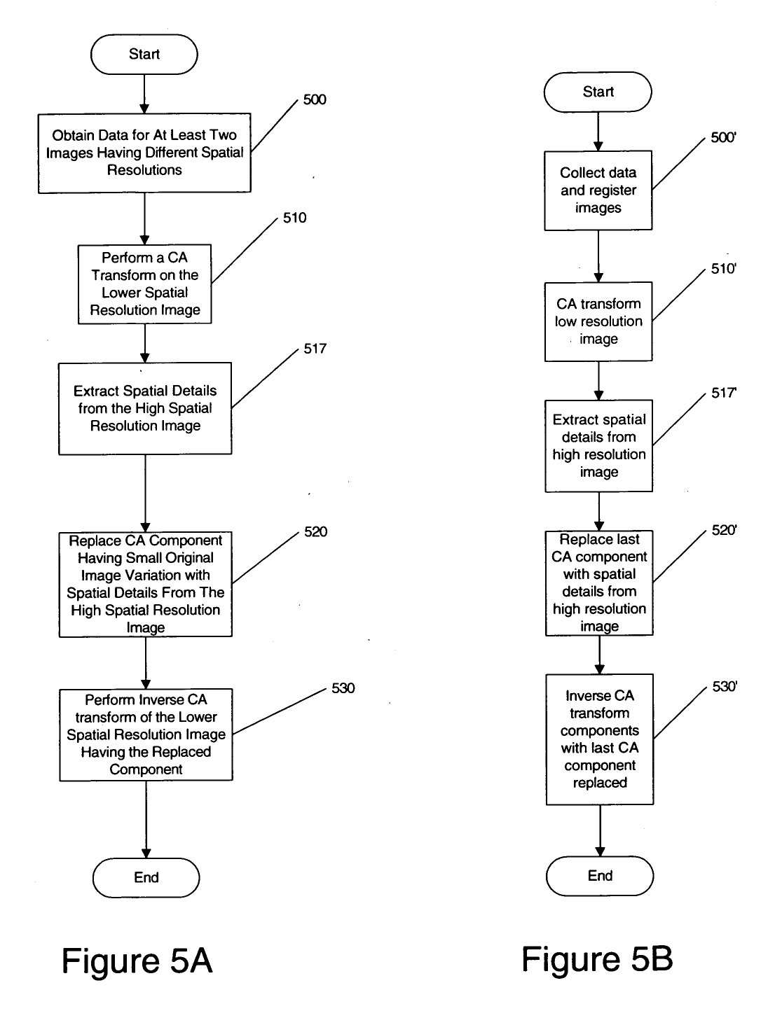

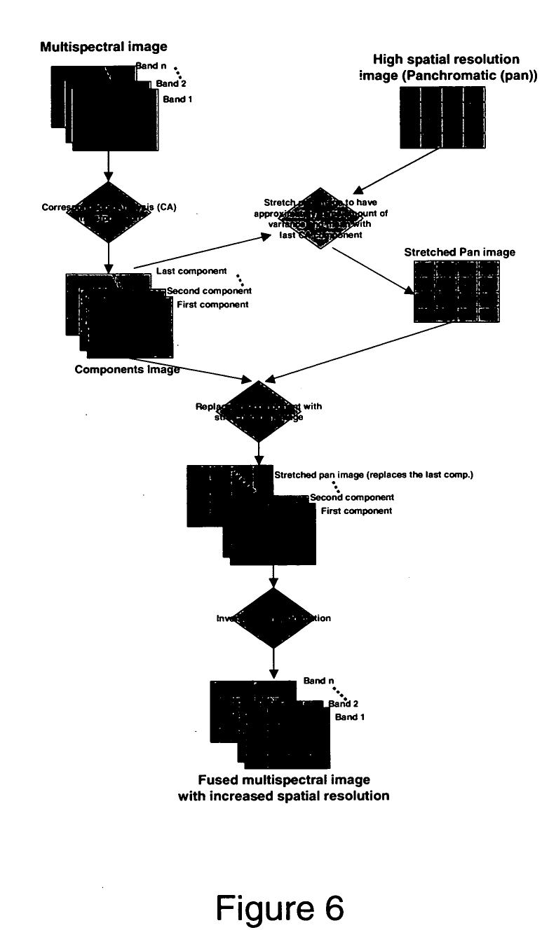

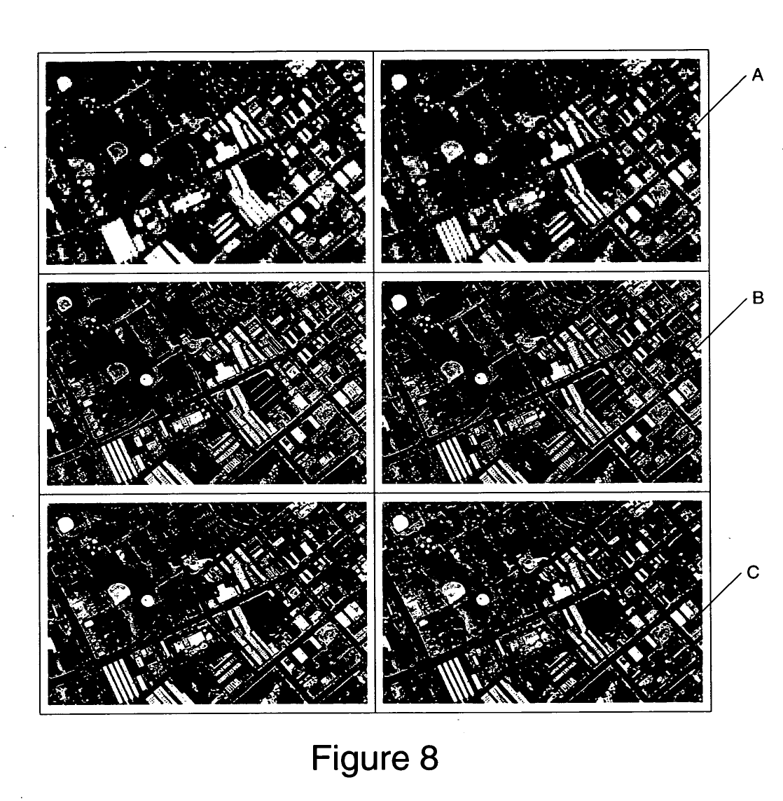

In some embodiments of the present invention, the information from the higher spatial resolution image may include the higher spatial resolution image scaled to correspond to a range of values in the component containing a small amount of information associated with the low spatial resolution image, which will be discussed further below with respect to FIGS. 4 and 6. In further embodiments of the present invention, the information from the higher spatial resolution image may include detail information obtained from the higher spatial resolution image as discussed further below with respect to FIGS. 5 and 8.

The data fusion circuit 260 may be further configured to perform an inverse transform of the component analysis transform of the lower spatial resolution image having the replaced component to provide the fused image. As discussed above, since the component that is replaced has a very small percentage of the information contained in the original image and is highly correlated to the high spatial resolution image that it is replaced with, the fused image may contain spectral characteristics that are very similar to the original (input) multispectral image. Thus, according to some embodiments of the present invention, the spectral characteristics of the original image may be preserved.

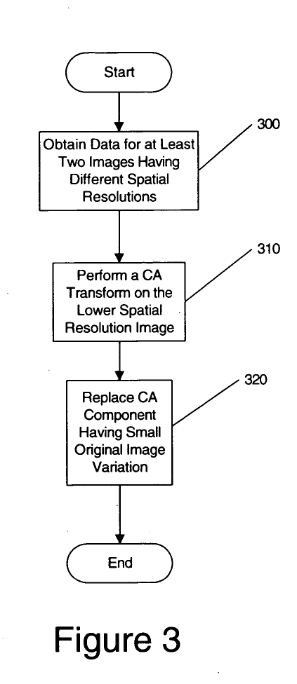

Operations of various embodiments of the present invention will now be discussed with respect to the flowcharts of FIGS. 3 through 7. Referring now to FIG. 3, operations begin at block 300 by obtaining data for at least two images having different spatial resolutions. In some embodiments of the present invention, the obtained data may include remotely sensed data including but not limited to aerial or satellite imagery. In some embodiments of the present invention the obtained data may be multispectral data, for example, color images, and high spatial resolution data, such as a panchromatic image or black and white image. In these embodiments of the present invention, both input images, i.e., the multispectral and high spatial resolution images, may be co-registered to each other so that the same objects in each image may appear at relatively the same place.

A component analysis (CA) transform may be performed on a lower spatial resolution image, for example, a multispectral or color image, of the at least two images (block 310). As discussed above, the CA transform may produce two or more components of the image each containing a certain percentage of the original image information. A component of the component analysis transform of the lower resolution image containing a small amount of information associated with the low spatial resolution image, for example, less than about five percent of the information, may be replaced with information from a higher spatial resolution image, for example, a panchromatic or black and white image, of the at least two images (block 320). In other words, for example, one of the components resulting from the CA is replaced with information from a corresponding higher spatial resolution image. In some embodiments of the present invention, the component that is replaced is the last component. The last component and the high spatial resolution image may be highly correlated. Thus, replacing the last component with the high spatial resolution image may not significantly affect the spectral characteristics of the original low spatial resolution image.

Referring now to FIG. 4A operations according to further embodiments of the present invention will be discussed. As illustrated in FIG. 4A, operations begin at block 400 by obtaining image data and registering the image data. For example, where the images are multispectral images and high spatial resolution images, such as a panchromatic image, both input images are co-registered to each other so that same objects in each of the images may appear at the relatively the same place. For example, the images may be registered such that the root-mean-square (RMS) error rate is within a pixel. Conventional image processing software packages may provide methods for geometric registration of images. The low spatial but high spectral resolution image, for example, a multispectral image or color image, is transformed into component space using the correspondence analysis (CA) procedure (block 410). This operation includes the calculation of an eigenmatrix for the transformation as discussed further below.

In embodiments of the present invention illustrated in FIG. 4A, the high spatial resolution image, for example, the panchromatic image, is also modified to have the same range and average values with the CA component having a small amount of information associated with the low spatial resolution image, for example, the last CA component (block 415). The high spatial resolution image may be modified using many different techniques, for example, data stretching may be used to provide a high spatial resolution image having the same range and average values as the last CA component. Furthermore, the high spatial resolution image can be modified to match the last CA component using histogram matching and the like. Although embodiments of the present invention are discussed herein with respect to data stretching and histogram matching, embodiments of the present invention are not limited to these techniques.

The CA component with a small amount of information, such as the last component, in the transformed lower spatial resolution image may be replaced with the modified high spatial resolution image (block 420). The transformed low spatial resolution image with the replaced component may be transformed back to the original data space using an inverse CA transformation (block 430). Thus, as discussed above, since the replace CA component and the modified high spatial resolution image are highly correlated and the replaced CA component contains a small amount of information associated with the low spatial resolution image, the resulting fused image may retain most of the spectral characteristics of the original low spatial resolution image (the input image). Furthermore, the resulting fused image may be a multispectral image with increased spatial resolution. Operations according to further embodiments of the present invention are illustrated in FIG. 4B in accordance with block 400′ to 430′.

Referring now to FIG. 5A, operations according to still further embodiments of the present invention will be discussed. As illustrated in FIG. 5A, operations begin at block 500 by obtaining and registering image data for images having different spatial resolutions. An image having a lower spatial resolution, for example, a multispectral image, of the images having different spatial resolution is transformed into component space using the correspondence analysis (CA) procedure (block 510). This operation includes the calculation of an eigenmatrix for the transformation as will be discussed further below.

In embodiments of the present invention illustrated in FIG. 5A, spatial details are extracted from a high spatial resolution image of the images having different spatial resolution using, for example, a multi-resolution approach (block 517). Spatial details can be described as the details between two successive spatial resolutions. For example, objects appear more detailed in higher spatial resolution images, for example, black and white or panchromatic images. At lower spatial resolutions, the objects appear more robust and with less spatial details. The spatial details can be represented as the ratios of pixel values at the highest spatial resolution (black and white) to the pixel values at the lower spatial resolution (color) of the same image. For example, small structural details not present at the 4-meter resolution level of a multispectral (color) IKONOS image can be extracted by dividing the degraded 4-meter panchromatic (black and white) image by the 1-meter panchromatic image. The resulting image is a ratio image that represents the details. Extraction of spatial details can be performed using many techniques and is not limited to the methods discussed herein. For example, the spatial details may be extracted using, for example, a wavelet method without departing from the scope of the present invention.

The spatial details extracted from the high spatial resolution images are inserted into a CA component containing a small amount of information associated with the low spatial resolution image, for example, the last CA component (block 520). In embodiments of the present invention utilizing the ratio method explained above, multiplying or dividing the ratio image with the last component may be used to insert the spatial details into the last CA component. The transformed multispectral images including the replaced last component is transformed back to original data space using an inverse CA transformation (block 530). Thus, as discussed above, since the last CA component and the modified high spatial resolution image are highly correlated and the last CA component contains a small amount of information associated with the low spatial resolution image, the resulting fused image may retain most of the spectral characteristics of the original low spatial resolution image (the input image). Furthermore, the resulting fused image may be a multispectral image with increased spatial resolution. Operations according to further embodiments of the present invention are illustrated in FIG. 5B in accordance with block 500′ to 530′.

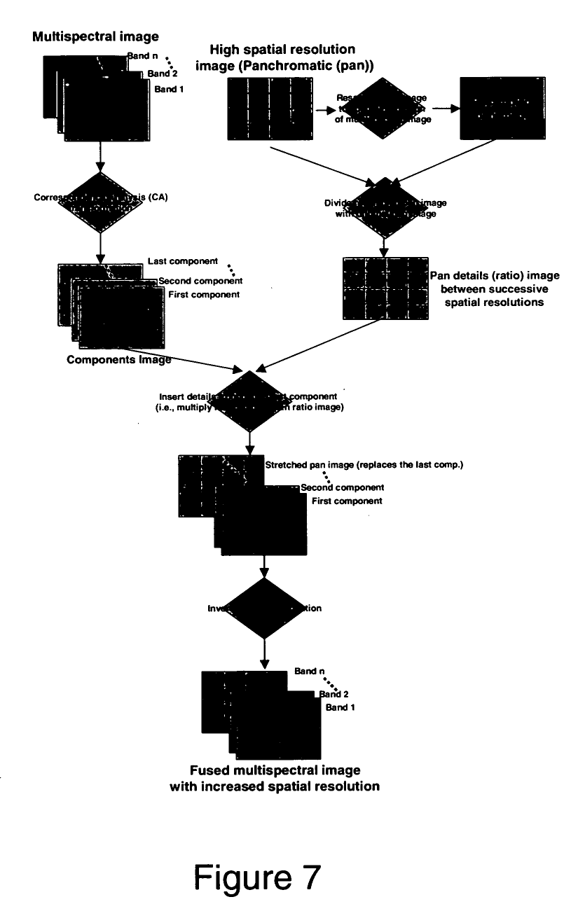

Referring now to FIGS. 6 and 7, flowcharts illustrating use of embodiments of the present invention for fusing multispectral images with a high spatial resolution image, such as a panchromatic image, will be discussed. Using the CA method according to some embodiments of the present invention, a data table (X) may be transformed into a table of contributions to the Pearson chi-square statistic. First, pixel (xᵢⱼ) values are converted to proportions (pᵢⱼ) by dividing each pixel (xᵢⱼ) value by the sum (x₊₊) of all the pixels in data set. The result is a new data set of proportions (Q) and the size is (rxc). Row weight pᵢ₊ is equal to x₊/x₊₊, where xᵢ₊ is the sum of values in row i. Vector [pᵢ₊] is of size (r). Column weight p₊ⱼ is equal to x₊ⱼ/x₊₊, where x₊ⱼ is the sum of values in column j. Vector [p₊ⱼ] is of size (c).

The Pearson chi-square statistic, χₚ², is a sum of squared χᵢⱼ values, computed for every cell ij of the contingency table:

$${χ}_{ij} = \frac{{o}_{ij} - {E}_{ij}}{\sqrt{{E}_{ij}}} = \sqrt{{x}_{++}} [ \frac{{p}_{ij} - {p}_{i +} {p}_{+ j}}{\sqrt{{p}_{i +} {p}_{+ j}}} ] \qquad Equation ( 1 )$$

If qᵢⱼ values are used instead of χᵢⱼ values, so that qᵢⱼ=χᵢⱼ/\sqrt{x}₊₊, eigenvalues will be smaller than or equal to 1. The qᵢⱼ values may be used to form the matrix \overline{Q}_{rxc}, which is:

$${\overline{Q}}_{rxc} = [ {q}_{ij} ] = [ \frac{{p}_{ij} - {p}_{i +} {p}_{+ j}}{\sqrt{{p}_{i +} {p}_{+ j}}} ] \qquad Equation ( 2 )$$

The matrix U may calculated by:
U_{cxc}=\overline{Q}_{cxr}^{T}\overline{Q}_{rxc} Equation (3)
Multispectral data is transformed into the component space using the matrix of eigenvectors.

Unlike the PCA fusion method, which substitutes the first component containing a significant amount of information associated with the input image with high spatial resolution imagery, the CA fusion method substitutes the last component having a small amount of information associated with the input image with the high spatial resolution imagery. In particular, as illustrated in FIGS. 4A, 4B and 6, in some embodiments of the present invention the last component (or component with a small amount of information associated with the input image) may be substituted or replaced with stretched high spatial resolution images, for example, a Panchromatic image or Pan data. Pan data may be stretched to have a same range and variance with the last CA component. As further illustrated in FIGS. 5A, 5B and 7, spatial details obtained from Pan data may be inserted into the last component. As discussed above, small structural details can be represented as the ratios of pixel values at the highest spatial resolution to the pixel values at the lower spatial resolutions of the same imagery. For example, small structural details not present at the 4-meter resolution level of multispectral IKONOS imagery can be extracted by dividing the degraded 4-meter panchromatic imagery with the 1-meter panchromatic imagery. The resulting image is a ratio image that represents the spatial details. This image may be multiplied by the last CA component.

Once the last component or component containing a small amount of information associated with the input image is replaced, the components image is transformed back to the original image space using the inverse matrix of eigenvectors.

The flowcharts and block diagrams of FIGS. 1 through 7 illustrate the architecture, functionality, and operation of possible implementations of systems, methods and computer program products according to various embodiments of the present invention. In this regard, each block in the flow charts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be understood that each block of the block diagrams and/or flowchart illustrations, and combinations of blocks in the block diagrams and/or flowchart illustrations, can be implemented by special purpose hardware-based systems which perform the specified functions or acts, or combinations of special purpose hardware and computer instructions.

Actual implementation examples using some embodiments of the present invention will now be discussed with respect to FIGS. 8 through 10. Results using methods of image fusion according to some embodiments of the present invention will be further discussed in comparison to results using the prior art PCA method of image fusion. An 11-bit IKONOS imagery of Wilson, N.C., may be used to compare the results of the CA techniques according to embodiments of the present invention and the PCA technique according to the prior art. In particular, in the examples discussed herein, IKONOS (4 band) multispectral images were fused with IKONOS panchromatic imagery. Both the multispectral and the panchromatic imagery were acquired at the same time and were already co-registered. Spectral ranges for the multispectral imagery are from 0.445 to 0.516 μm for band 1 (blue), from 0.506 to 0.595 μm for band 2 (green), from 0.632 to 0.698 μm for band 3 (red), and from 0.757 to 0.853 μm for band 4 (near infrared). The panchromatic band overlaps the spectral range of the multispectral imagery (0.52-0.92 μm). Mean pixel values and standard deviations for both images are provided in Table 1 set out below. It will be understood that only a subset of the actual study area is illustrated in Figures discussed herein.

TABLE 1

| | Band 1 | Band 2 | Band 3 | Band 4 | Pan |
|---|---|---|---|---|---|
| Mean | 587.8679 | 705.3507 | 693.6767 | 650.5273 | 659.88 |
| STD | 337.8023 | 323.6774 | 338.2661 | 422.1936 | 294.397 |

Mean Pixel Values and Standard Deviations for Wilson, N.C. Scene

Visually, the last CA component is more similar to the panchromatic image black and white image) than the first CA component or the PCA component. In other words, as discussed above, the last CA component is highly correlated to the panchromatic image. As illustrated by Table 2 listing correlation coefficients between panchromatic imagery and the components, comparison of the correlation coefficients between the panchromatic band and the component images confirms that the similarity between the last CA component and the panchromatic band is higher than the other CA components or any PCA components. In other words, the last CA component has a much higher correlation coefficient to the panchromatic imagery than the first PCA component.

TABLE 2

| | CA | PCA |
|---|---|---|
| Component 1 | −0.07532 | 0.663249 |
| Component 2 | −0.16652 | 0.7101 |
| Component 3 | −0.05798 | −0.01743 |
| Component 4 | 0.908446 | −0.02998 |

Correlation Coefficients Between Panchromatic Imagery and Principal Components.

Eigenvalues of principal components and the amount of original image variance represented are provided below in Table 3. The amount of original image variance captured by the last CA component was so small that this component can basically be ignored for data compression purposes as discussed in Correspondence Analysis for Principal Components Transformation of Multispectral and Hyperspectral Digital Images by Carr et al. (1999).

TABLE 3

| | Correspondence | | Principal Component | |
|---|---|---|---|---|
| | Components Analysis | | Analysis | |
| | | % Variance | | % Variance |
| IKONOS data | Eigenvalues | Explained | Eigenvalues | Explained |
| Component 1 | 0.149829 | 97.53 | 3.60E+05 | 66.56 |
| Component 2 | 0.002855 | 1.86 | 1.74E+05 | 32.18 |
| Component 3 | 0.000939 | 0.61 | 5.77E+03 | 1.07 |
| Component 4 | 4.57E−15 | 2.97E−12 | 1.06E+03 | 0.20 |
| Sum | 0.153623 | | 5.41E+05 | |

Eigenvalues and the Original Image Variance Represented by the Eigenvalues

The first principal component of both the CA method and the PCA method captures most of the original image variance. Thus, substituting the first principal component, which captures most of the original image variance with panchromatic imagery, as taught by the PCA method, may heavily distort the original image variance. In contrast, using the CA techniques according to embodiments of the present invention, a significant portion of the original image variance may be retained in the fused imagery by substituting the last component, which captures a very small amount of the original image variance, with the panchromatic imagery. Specifically with respect to the example of the Wilson scene discussed herein, the first PCA component captures 66.5 percent of the variation of the original image, therefore 66.5 percent of the original image variance is altered when the first PCA component is replaced with the panchromatic image. In contrast, the last CA component only captures 2.97E-12 percent of the variation of the original image, therefore, the CA method may retain most of the original image variance.

Referring now to FIG. 8, a side by side display illustrating original and fused images created using different methods will be discussed. The left side images of FIG. 8 are true color composites (Bands 1, 2, and 3) and the right side images of FIG. 8 are false color composites (Bands 2, 3, and 4). The images in the first row A are the original (input image), the images in the second row B are the fused images resulting from CA methods according to embodiments of the present invention and the images in the last row C are the fused images resulting from the prior art PCA method. The images in the second row B illustrate the results of the CA method according to embodiments of the present invention where the last component is replaced by the special details of the panchromatic image (Embodiment 2) as discussed above.

The results of the experiment showed that CA methods according to embodiments of the present invention where the last CA component is substituted with pan data (not illustrated in FIG. 8 (Embodiment 1)) provides the sharpest image. However, the color balance when compared to the original image, was best preserved in CA embodiments of the present invention using the special details (Embodiment 2) because only small structural details are imported to the last component. As suspected, the results of the PCA method were the worst among all techniques in terms of preserving the color balance, thus, suggesting that the PCA method alters, to some degree, the spectral characteristics of the image.

To assess the quality or the performance of the fusion techniques quantitatively, a similar approach to one described in Fusion of Satellite Images of Different Resolutions: Assessing the Quality of Resulting Images by Wald et al. (1997) was used. First, fused images were degraded to original image resolution for comparison purposes. Biases, differences in variances, correlation coefficients between the original and the fused images, and the standard deviations of the difference images were investigated for all methods. These statistics are set out in Table 4 below. Bias was assessed as the differences between the mean pixel values of the original image and the fused image. Differences in variances were calculated as the original image variance minus the fused image variance. A correlation coefficient between the original and the fused image is the Pearson's correlation coefficient and shows the similarity between small size structures. The last criterion in Table 4 is the standard deviation of the differences between the original and fused image (differences image), and indicates the level of global error for each pixel.

TABLE 4

| | PCA | CA Method 1 | CA Method 2 |
|---|---|---|---|
| Band 1 | | | |
| Bias (ideal value: 0) | 37.468 | −0.961 | 0.057 |
| relative to the original band 1 mean pixel value | 6.37% | −0.16% | 0.0096% |
| Difference in variances (ideal value: 0) | 48456.563 | 33456.830 | 8.218 |
| relative to the original band 1 variance | 42.46% | 29.32% | 0.0068% |
| Correlation coefficient between original band 1 | 0.675 | 0.961 | 1 |
| and fused band 1 (ideal value: 1) | | | |
| Standard Deviation of the differences (ideal value: 0) | 252.35 | 104.753 | 0.293 |
| relative to the mean of the original band 1 | 42.92% | 17.82% | 0.0498% |
| Band 2 | | | |
| Bias (ideal value: 0) | 36.011 | −1.053 | 0.062 |
| relative to the original band 2 mean pixel value | 5.11% | −0.15% | 0.0088% |
| Difference in variances (ideal value: 0) | 33242.922 | 29179.724 | 7.102 |
| relative to the original band 2 variance | 31.76% | 27.85% | 0.0068% |
| Correlation coefficient between original band 2 | 0.683 | 0.943 | 1 |
| and fused band 2 (ideal value: 1) | | | |
| Standard Deviation of the differences (ideal value: 0) | 242.308 | 114.8 | 0.321 |
| relative to the mean of the original band 2 | 34.35% | 16.27% | 0.0455% |
| Band 3 | | | |
| Bias (ideal value: 0) | 37.507 | −1.044 | 0.061 |
| relative to the original band 3 mean pixel value | 5.41% | −0.15% | 0.0089% |
| Difference in variances (ideal value: 0) | 43779.620 | 34187.110 | 7.791 |
| relative to the original band 3 variance | 38.26% | 29.88% | 0.0068% |
| Correlation coefficient between original band 3 | 0.681 | 0.952 | 1 |
| and fused band 3 (ideal value: 1) | | | |
| Standard Deviation of the differences (ideal value: 0) | 252.599 | 113.8 | 0.318 |
| relative to the mean of the original band 3 | 36.41% | 16.41% | 0.0458% |
| Band 4 | | | |
| Bias (ideal value: 0) | −3.813 | −1.013 | 0.060 |
| relative to the original band 4 mean pixel value | −0.59% | −0.16% | 0.0092% |
| Difference in variances (ideal value: 0) | 18255.412 | −69298.997 | −14.892 |
| relative to the original band 4 variance | 10.24% | −38.88% | −0.0080% |
| Correlation coefficient between original band 4 | 0.999 | 0.985 | 1 |
| and fused band 4 (ideal value: 1) | | | |
| Standard Deviation of the differences (ideal value: 0) | 29.41 | 110.3951 | 0.308 |
| relative to the mean of the original band 4 | 4.52% | 16.97% | 0.0473% |

Statistics on the Differences Between the Original and Fused Images in Pixel and Relative Values

As illustrated by the values set out in Table 4, the PCA method performed poorly in all aspects of Table 4 when compared to the CA method according to embodiments of the present invention, with the exception of in band 4. PCA outperforms the CA Embodiment 1 according to some embodiments of the present invention in band 4 in terms of the correlation coefficient and the standard deviation of the differences. The CA Embodiment 2 according to further embodiments of the present invention performs very 10 well throughout the table. Biases are low for all bands. Differences in variances are less than a ten thousandth of the original image variances. For all practical purposes, the fused images are almost perfectly correlated to the original images. The standard deviations of the differences images are less than a thousandth of the original image mean values.

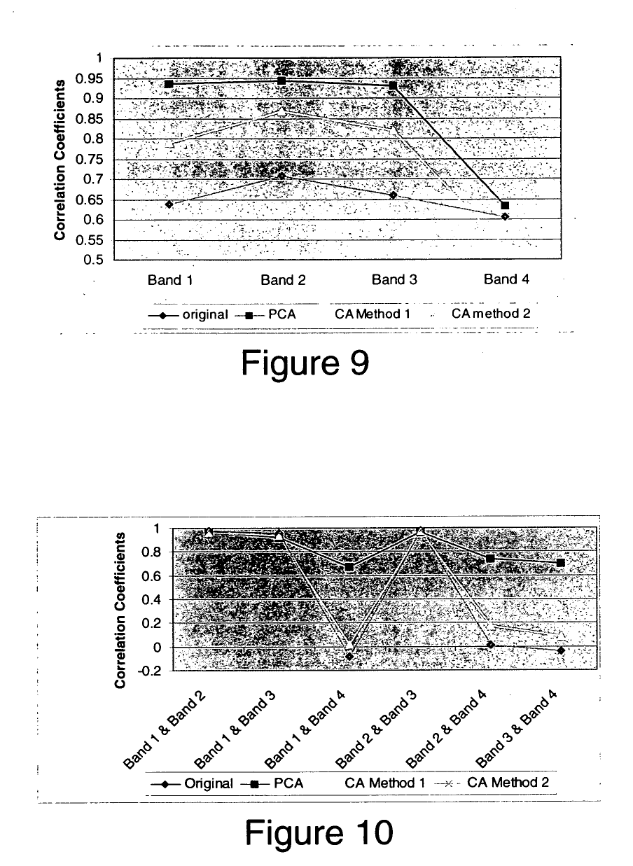

Referring now to FIG. 9, a graph illustrating the correlation coefficients of panchromatic data versus original and fused images will be discussed. To investigate which technique least distorts the original spectral characteristics, correlations to panchromatic data were also investigated as well as the between-band correlations. As illustrated in FIG. 9, the CA Embodiment 1 according to some embodiments of the present invention is labeled CA Method 1 and the CA Embodiment 2 according to further embodiments of the present invention is labeled CA Method 2. Ideally, the correlation coefficients of each band to pan should not deviate from the original image vs. pan values. Correlation coefficients of CA Embodiment 2 images (all bands) to the panchromatic image are very close to the original image (differences are less than 0.0001). As expected, the PCA method increases the correlations to the panchromatic imagery, especially in the first three bands. The CA Embodiment 1 does relatively well, but it also alters this property.

Referring now to FIG. 10, a graph of between-band correlation coefficients illustrating original, Component Analysis (CA) methods 1 and 2 according to embodiments of the present invention and PCA method images will be discussed. As illustrated in FIG. 10, the analysis of between-band correlation coefficients for original and fused images (CA Embodiment 1 (labeled CA Method 1), CA Embodiment 2 (labeled CA method 2), and PCA) shows that CA method 2 is very good for preserving this property. The ideal value being given by the original images, the between-band correlation coefficients should be as close as possible to the original images. For CA Embodiment 2, between-band correlation coefficients are very close to those of the original multispectral image (differences are less than 0.00002). The PCA method increases the between-band correlations. Correlations between band 4 and other bands are especially increased by the PCA method.

Only the results for a small scene of IKONOS imagery (512×512 pixels for multispectral and 2048×2048 pixels for panchromatic imagery) are discussed above. However, techniques according to embodiments of the present invention were also applied to a larger IKONOS imagery covering 81 km² of watershed area of Hominy Creek near Wilson, N.C. Similar results were also obtained for the larger scene. For the Hominy Creek scene, the 4-meter multispectral IKONOS imagery and the 1-meter fused (both PCA and CA method-1) IKONOS images were classified into eight land use/land cover (LU/LC) categories using a supervised classification technique for an ongoing project. The results showed that the best classification was attained using 1-meter CA fused image as discussed in Comparison of Remotely Sensed Data from Different Sensors with Different Spatial and Spectral Resolutions to Detect and Characterize Riparian Stream Buffer Zones to Khorram et al. (2003). Overall classification accuracy was %52, %43, and %39 for 1-meter CA fused IKONOS, 4-meter IKONOS (original), and 1-meter PCA fused IKONOS multispectral images, respectively. Decline in overall classification accuracy in PCA fused image was caused by the spectral information lost. On the other hand, overall classification accuracy was significantly improved over 4-meter IKONOS image by using 1-meter CA fused image, which is the result of improved spatial resolution while preserving the spectral information.

As briefly discussed above, correspondence analysis (CA) according to some embodiments of the present invention provides for the fusion of high spectral resolution imagery, for example, IKONOS multispectral, with high spatial resolution imagery, for example, IKONOS pan, at the pixel level. As illustrated by the examples discussed above, the CA methods according to some embodiments of the present invention may provide a substantial improvement over the prior art PCA method. The CA methods according to some embodiments of the present invention preserve the chi-square (χ²) distance when computing the association between spectral values in various bands and fusion takes place in the last component as opposed to the first component in PCA. Because the last component has almost zero original image variance in the CA methods, altering the last component may not significantly affect the spectral content of the original image.

As further illustrated by the comparative example discussed above, by replacing the first component with the panchromatic image in the PCA method, most of the original image variance is altered. This could be acceptable if the panchromatic imagery is the same as the first principal component. However, many times they are not exactly the same even with the panchromatic imagery spectrally overlapping the multispectral imagery (as in IKONOS). Depending on the scene characteristics and the contents of the imagery, the correlation between the panchromatic image and the first PCA component could be high and the PCA method may perform well but it is not the case at all times.

In contrast, the CA method according to some embodiments of the present invention does not alter much of the original image because the fusion process takes in the last component that represents a small (almost zero) amount of the original image variance. This can be best seen when analyzing the between-band correlations as discussed above. The PCA method increases the between-band correlations. The CA methods, on the other hand, alter the original between-band correlations to a small degree. This suggests that the resulting fused multispectral image can be used for classification purposes. Because the PCA makes all bands highly correlated to each other, most of the spectral information is lost in this method, thus, possibly causing the resulting fused image to be poorly suited for classification purposes.

In CA Embodiment 2 according to some embodiments of the present invention, adding small size structural details from panchromatic imagery to the last CA component provided the best results in the example discussed above. Although a simple technique is discussed herein for inserting the spatial details into the last component, embodiments of the present invention are not limited to this method of insertion. For example, more advanced techniques can be used to insert spatial details between two spatial resolutions. In particular, wavelets may provide ways of extracting the details from high spatial resolution imagery and inserting them into the last CA component.

In the drawings and specification, there have been disclosed typical illustrative embodiments of the invention and, although specific terms are employed, they are used in a generic and descriptive sense only and not for purposes of limitation, the scope of the invention being set forth in the following claims.

1. A method of fusing images having different spatial resolutions, comprising:
obtaining data for at least two images having different spatial resolutions;
performing a component analysis transform on a lower spatial resolution image of the at least two images; and
replacing a component of the component analysis transform of the lower spatial resolution image containing a small amount of information associated with the low spatial resolution image with information from a higher spatial resolution image of the at least two images.

2. The method of claim 1, further comprising performing an inverse transform of the component analysis transform of the lower spatial resolution image having the replaced component.

3. The method of claim 2, wherein replacing comprises:
modifying the higher spatial resolution image to have the same range and average values as the component containing a small amount of information associated with the low spatial image; and
replacing a component of the component analysis transform of the lower spatial resolution image containing a small amount of information associated with the low spatial resolution image with the modified higher spatial image.

4. The method of claim 2, wherein replacing comprises:
generating a ratio of pixel values associated with the high spatial resolution image and pixel values associated with the low resolution image to provide spatial details; and
inserting the spatial details into the component of the component analysis transform of the lower spatial resolution image containing a small amount of information associated with the low spatial resolution image.

5. The method of claim 4, wherein inserting comprises multiplying or dividing the spatial details with the component of the component analysis transform of the lower spatial resolution image containing a small amount of information associated with the low spatial resolution image.

6. The method of claim 2, wherein the component containing the small amount of information associated with the low spatial resolution image is highly correlated with the higher spatial resolution image.

7. The method of claim 2, wherein the information from the higher spatial resolution image comprises the higher spatial resolution image scaled to correspond to a range of values in the component containing a small amount of information associated with the low spatial resolution image.

8. The method of claim 2, wherein the information from the higher spatial resolution image comprises detail information obtained from the higher spatial resolution image.

9. The method of claim 2, wherein the lower spatial resolution image containing a small amount of information associated with the low spatial resolution image comprises less than about five percent of the information associated with the low spatial resolution image.

10. The method of claim 2, wherein the component of the component analysis transform of the lower resolution image comprises a last component of the component analysis transform, wherein the high spatial resolution image comprises a panchromatic and/or a black and white image and wherein the low spatial resolution image comprises a multispectral and/or a color image.

11. The method of claim 2, wherein the lower spatial resolution image comprises a higher spectral resolution than the higher spatial resolution image.

12. A system for fusing images having different spatial resolutions comprising a data fusion circuit configured to:
obtain data for at least two images having different spatial resolutions;
perform a component analysis transform on a lower spatial resolution image of the at least two images; and
replace a component of the component analysis transform of the lower spatial resolution image containing a small amount of information associated with the low spatial resolution image with information from a higher spatial resolution image of the at least two images.

13. The system of claim 12, wherein the data fusion circuit is further configured to perform an inverse transform of the component analysis transform of the lower spatial resolution image having the replaced component.

14. The system of claim 13, wherein the data fusion circuit is further configured to modify the higher spatial resolution image to have the same range and average values as the component containing a small amount of information associated with the low spatial image and replace the component of the component analysis transform of the lower spatial resolution image containing a small amount of information associated with the low spatial resolution image with the modified higher spatial image.

15. The system of claim 13, wherein the data fusion circuit is further configured to generate a ratio of pixel values associated with the high spatial resolution image and pixel values associated with the low resolution image to provide spatial details and insert the spatial details into the component of the component analysis transform of the lower spatial resolution image containing a small amount of information associated with the low spatial resolution image.

16. The system of claim 15, wherein the data fusion circuit is further configured to multiply or divide the spatial details with the component of the component analysis transform of the lower spatial resolution image containing a small amount of information associated with the low spatial resolution image to insert the spatial details.

17. The system of claim 13, wherein the component containing the small amount of information associated with the low spatial resolution image is highly correlated with the higher spatial resolution image.

18. The system of claim 13, wherein the information from the higher spatial resolution image comprises the higher spatial resolution image scaled to correspond to a range of values in the component containing a small amount of information associated with the low spatial resolution image.

19. The system of claim 13, wherein the information from the higher spatial resolution image comprises detail information obtained from the higher spatial resolution image.

20. The system of claim 13, wherein the lower spatial resolution image containing a small amount of information associated with the low spatial resolution image comprises less than about five percent of the information associated with the low spatial resolution image.

21. The system of claim 13, wherein the component of the component analysis transform of the lower resolution image comprises a last component of the component analysis transform, wherein the high spatial resolution image comprises a panchromatic and/or a black and white image and wherein the low spatial resolution image comprises a multispectral and/or a color image.

22. The system of claim 13, wherein the lower spatial resolution image comprises a higher spectral resolution than the higher spatial resolution image.

23. A system for fusing images having different spatial resolutions comprising:
means for obtaining data for at least two images having different spatial resolutions;
means for performing a component analysis transform on a lower spatial resolution image of the at least two images; and
means for replacing a component of the component analysis transform of the lower spatial resolution image containing a small amount of information associated with the low spatial resolution image with information from a higher spatial resolution image of the at least two images.

24. The system of claim 23, further comprising means for performing an inverse transform of the component analysis transform of the lower spatial resolution image having the replaced component.

25. The system of claim 24, wherein the means for replacing comprises:
means for modifying the higher spatial resolution image to have the same range and average values as the component containing a small amount of information associated with the low spatial image; and
means for replacing a component of the component analysis transform of the lower spatial resolution image containing a small amount of information associated with the low spatial resolution image with the modified higher spatial image.

26. The system of claim 24, wherein the means for replacing comprises:
means for generating a ratio of pixel values associated with the high spatial resolution image and pixel values associated with the low resolution image to provide spatial details; and
means for inserting the spatial details into the component of the component analysis transform of the lower spatial resolution image containing a small amount of information associated with the low spatial resolution image.

27. The system of claim 26, wherein the means for inserting comprises means for multiplying or dividing the spatial details with the component of the component analysis transform of the lower spatial resolution image containing a small amount of information associated with the low spatial resolution image.

28. The system of claim 24, wherein the component containing the small amount of information associated with the low spatial resolution image is highly correlated with the higher spatial resolution image.

29. A computer program product for fusing images having different spatial resolutions, the computer program product comprising:
computer readable storage medium having computer readable program code embodied in said medium, the computer readable program code comprising:
computer readable program code configured to obtain data for at least two images having different spatial resolutions;
computer readable program code configured to perform a component analysis transform on a lower spatial resolution image of the at least two images; and
computer readable program code configured to replace a component of the component analysis transform of the lower spatial resolution image containing a small amount of information associated with the low spatial resolution image with information from a higher spatial resolution image of the at least two images.

30. The computer program product of claim 29, further comprising computer readable program code configured to perform an inverse transform of the component analysis transform of the lower spatial resolution image having the replaced component.

31. The computer program product of claim 30, wherein the computer readable program code configured to replace comprises:
computer readable program code configured to modify the higher spatial resolution image to have the same range and average values as the component containing a small amount of information associated with the low spatial image; and
computer readable program code configured to replace a component of the component analysis transform of the lower spatial resolution image containing a small amount of information associated with the low spatial resolution image with the modified higher spatial image.

32. The computer program product of claim 30, wherein the computer readable program code configured to replace comprises:
computer readable program code configured to generate a ratio of pixel values associated with the high spatial resolution image and pixel values associated with the low resolution image to provide spatial details; and
computer readable program code configured to insert the spatial details into the component of the component analysis transform of the lower spatial resolution image containing a small amount of information associated with the low spatial resolution image.

33. The computer program product of claim 32, wherein the computer readable program code configured to insert comprises computer readable program code configured to multiply or divide the spatial details with the component of the component analysis transform of the lower spatial resolution image containing a small amount of information associated with the low spatial resolution image.

34. The computer program product of claim 30, wherein the component containing the small amount of information associated with the low spatial resolution image is highly correlated with the higher spatial resolution image.

35. The computer program product of claim 30, wherein the information from the higher spatial resolution image comprises the higher spatial resolution image scaled to correspond to a range of values in the component containing a small amount of information associated with the low spatial resolution image.

36. The computer program product of claim 30, wherein the information from the higher spatial resolution image comprises detail information obtained from the higher spatial resolution image.

37. The computer program product of claim 30, wherein the lower spatial resolution image containing a small amount of information associated with the low spatial resolution image comprises less than about five percent of the information associated with the low spatial resolution image.

38. The computer program product of claim 30, wherein the component of the component analysis transform of the lower resolution image comprises a last component of the component analysis transform, wherein the high spatial resolution image comprises a panchromatic and/or a black and white image and wherein the low spatial resolution image comprises a multispectral and/or a color image.

39. The computer program product of claim 30, wherein the lower spatial resolution image comprises a higher spectral resolution than the higher spatial resolution image.
